(19) United States
(12) Patent Application Publication
(10) Pub. No.: US 2015/0267833 A1
(43) Pub. Date: Sep. 24, 2015

(54) TANK DRAINAGE DEVICE

(71) Applicant: SIEMENS AG OESTERREICH, Wien (AT)

(72) Inventors: Claudio Cipone, Wien (AT); Klaus Ulreich, Pinkafeld (AT)

(73) Assignee: SIEMENS AG OESTERREICH, Wien (AT)

(21) Appl. No.: 14/434,170

(22) PCT Filed: Oct. 2, 2013
(86) PCT No.: PCT/EP2013/070502

§ 371 Date: Apr. 8, 2015

(30) Foreign Application Priority Data
Oct. 8, 2012 (AT) A50433/2012

(51) Int. Cl. F16K 31/00; B61D 5/00; F16K 31/48

(52) U.S. Cl. CPC F16K 31/002; F16K 31/48; B61D 5/00

(57) ABSTRACT

A tank drainage device for a fresh water tank on a rail vehicle includes a thermostatic switch disposed on a drainage line and thermally coupled to the fresh water. In the event of the temperature in the tank falling below a predefined temperature, the thermostatic switch triggers a timing element which thereby opens a drainage valve for a predefined period.

### TECHNICAL FIELD

The invention relates to a tank drainage device for fresh water tanks on rail vehicles.

### BACKGROUND ART

Rail vehicles, in particular passenger rail vehicles, frequently contain fresh water tanks for supplying sanitary units, galleys or the like. Because these tanks may contain drinking water, they are liable to freeze up if the vehicle is stationary for any length of time in cold weather conditions. While the vehicle is in operation, this danger does not exist because the tanks are generally arranged in the heated interior, typically in the ceiling above the sanitary unit. If the contents of a fresh water tank freeze, the vehicle cannot be used since the sanitary facilities are not operational and the vehicle needs to be warmed up in a heated hangar. Due to the large volumes of water, amounting to approx. 300 liters, such a process can take several days. If pipelines are damaged as a result of the water freezing, they have to be repaired. In order to solve this problem, rail vehicles containing fresh water tanks are fitted with automatic drainage devices which drain off a filled tank by means of a drainage valve if the temperature of the tank falls below a predefined level. These devices require an electrical power supply, which is provided by means of an onboard battery when vehicles are parked up. It is necessary to design said drainage devices as energy-efficient in order to enable the protection to be maintained over a relatively long period of time (several weeks). Furthermore, it is important that the drainage devices do not trip incorrectly, since such a vehicle (with empty fresh water tank) can be used only subject to severe restrictions or, as the case may be, the tank can be refilled only in certain stations.

### SUMMARY OF THE INVENTION

The object underlying the invention is therefore to disclose a tank drainage device for fresh water tanks on rail vehicles which prevents false trips and is power-saving.

The object is achieved by means of a tank drainage device having the features recited in claim 1. Advantageous embodiments are the subject matter of dependent claims.

According to the basic concept of the invention, a tank drainage device is constructed for a fresh water tank of a rail vehicle, wherein a thermostatic switch is thermally coupled to the fresh water and, in the event of the temperature in the tank falling below a predefined temperature, triggers a timing element, which thereby opens a drainage valve for a predefined period of time, and wherein the thermostatic switch is arranged on a drainage line.

The advantage that is achievable by this means is that a fresh water tank of a rail vehicle is able to be drained automatically in the event of the temperature falling below a predefined minimum temperature.

According to the invention, a thermostatic switch is provided which is arranged in such a way that it is able to detect the temperature of the fresh water. In particular it is advantageous to arrange the thermostatic switch at those parts of the tank or drainage system which are first to become blocked by freezing water if the outside temperature drops. The drainage line discharges the water out of the railcar body into the outside environment and is immediately exposed to the ambient temperature, so the thermostatic switch should be arranged on said drainage line. Furthermore, a frozen drainage line would prevent the tank from being emptied in any case.

One embodiment variant of the invention provides using a thermostatic switch having a difference of less than 5 Kelvin between the turn-on value and the turn-off value. Conventional thermostatic switches have much greater switching point differences, with the consequence that the drainage process is initiated at much higher temperatures than necessary. Conventional thermostatic switches have neither the necessary switching point precision nor the necessary low switching point hysteresis. By using a thermostatic switch according to the invention (precision thermostatic switch) it is possible to dimension the tripping temperature considerably closer to zero degrees Celsius, typically to a value of two degrees Celsius. Such a thermostatic switch has a precision of one degree Celsius, which means that the drainage process is initiated between one and three degrees Celsius in any event.

Conventional thermostats, in contrast, must be set to much higher temperatures due to their imprecisions, a drainage process commencing already at approx. ten degrees Celsius in particularly unfavorable cases. Owing to the high precision of the thermostatic switch according to the invention, the turn-off threshold can be dimensioned to a value of four degrees Celsius, such that, given a precision of one degree Celsius, the thermostatic switch will interrupt the drainage process at any event in a temperature range between three and five degrees Celsius. Such a thermostatic switch has a difference of less than 5 Kelvin between the turn-on value and the turn-off value.

Conventional tank drainage devices are equipped with a device for measuring the fill level; such a device is not necessary in the case of the present invention. The advantage that is realizable by this means is that it is possible to achieve a reduction in the energy consumption of the tank drainage device, since in general the fill level is measured by means of an ultrasonic sensor and such a sensor requires electrical energy for its operation.

The current fill level of the fresh water tank is irrelevant in the case of the tank drainage device that is the subject matter of the present invention, since the thermostatic switch triggers a timing element which opens a drainage valve for a predefined period of time. Said period of time needs to be coordinated with the volume of the tank and the discharge volume per unit time through the drainage line in order to ensure that the tank is emptied in any event. In this case the timing element is typically required to be set to a drainage time of 30 minutes in the case of conventional tanks.

Another embodiment variant of the invention provides not to supply the energy supply of the timing element continuously with voltage, but likewise to take said energy supply from the signal transmitted by the thermostatic switch. In such a manner the energy consumption of the tank drainage device can be reduced to zero during the time up to the tripping (commencement of draining). A thermostatic switch has zero energy consumption, the timing element triggered by it consuming energy only during the drainage process, as also does the drainage valve actuated by the timing element. In such a manner a tank drainage device can be constructed which imposes only a minimum load on the vehicle power supply and as a result ensures the longest possible period of use of the tank drainage device for a specific battery capacity.

### BRIEF DESCRIPTION OF THE DRAWINGS

By way of example:

FIG. 1 shows a tank drainage device according to the prior art.

FIG. 2 shows a tank drainage device.

FIG. 3 shows a circuit of a tank drainage device.

### DESCRIPTION OF THE INVENTION

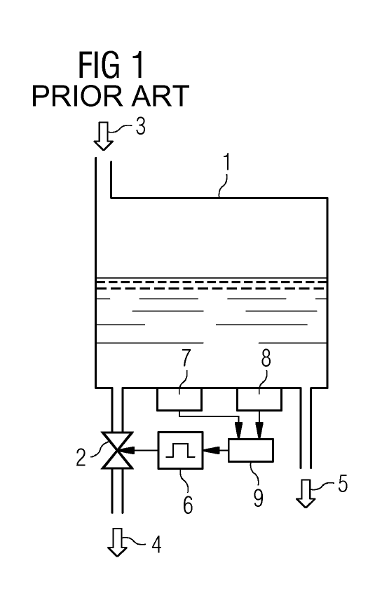

FIG. 1 is a schematic showing by way of example a tank drainage device according to the prior art. A fresh water tank 1 of a rail vehicle is illustrated which has an inlet 3, a supply line 5 for supplying water-consuming loads such as washbasins or galleys, and an outlet 4 for draining the tank 1. The outlet 4 is fitted with a drainage valve 2 which can be actuated and opened electrically, as a result of which the contents of the tank 1 drain off into the outside environment. A control device 9 receives sensor signals from an ultrasonic sensor 8 and a thermostatic switch 7. The ultrasonic sensor 8 detects the current fill level of the tank 1, while the thermostatic switch 7 determines the temperature of the tank 1 or, more accurately, the temperature of the water contained therein and, in the event that the temperature falls below a predefined temperature, outputs a signal to the control device 9. From the signals provided by the thermostatic switch 7 and the ultrasonic sensor, said control device 9 determines the need for the tank to be drained, in which case an already empty tank, for example, no longer leads to an opening of the drainage valve 2 even if the temperature falls below a predefined level. The control device 9 triggers a timing element 6, which, following said actuation, opens the drainage valve 2 for a predefined period of time.

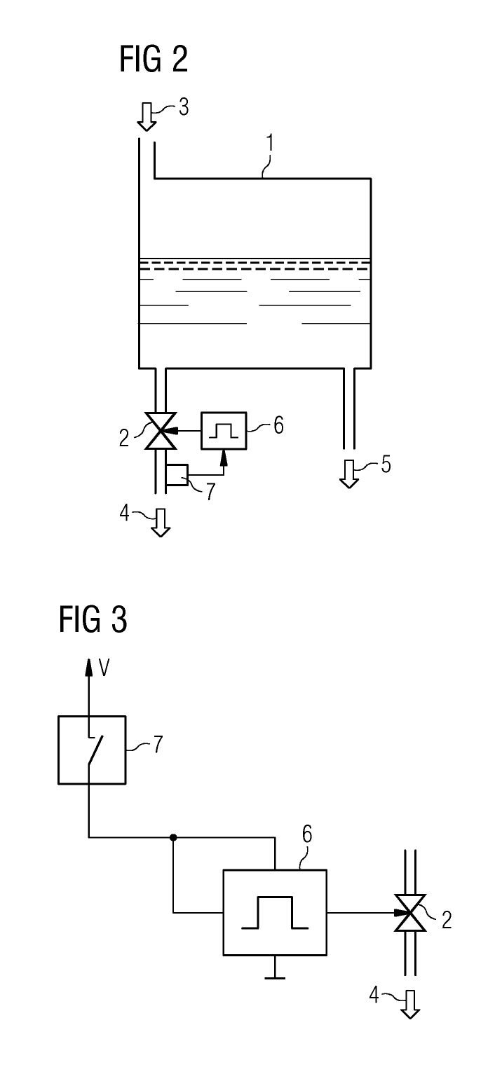

FIG. 2 is a schematic showing by way of example a tank drainage device. A tank drainage device according to the invention is illustrated, the tank 1 being substantially unchanged. A thermostatic switch 7 is provided which is arranged at the outlet 4. By being mounted at this position the thermostatic switch 7 is able to detect a tripping temperature at an early stage, since this point cools down much more quickly than the tank 1. The thermostatic switch 7 instantly triggers a timing element 6, which opens the drainage valve 2 for a predefined period of time. An ultrasonic sensor 8 or some other fill level detecting means is not provided because such a component is not required in the case of a tank drainage device according to the invention.

FIG. 3 is a schematic showing by way of example a circuit of a tank drainage device. The electrical circuit of a tank drainage device according to the exemplary embodiment shown in FIG. 2 is illustrated. The thermostatic switch 7 is depicted in the open state, in other words at a higher temperature than the tripping temperature. A voltage supply V is connected to a terminal of the thermostatic switch 7. This voltage supply can be taken directly from the vehicle battery. The output of the thermostatic switch 7 is connected both to the control input and to the voltage supply input of the timing element 6. The timing element 6 additionally comprises a ground terminal. The output of the timing element 6 is connected to the control terminal of the drainage valve 2. In the inoperative condition this circuit consumes zero energy, as a result of which the energy stored in the vehicle battery is sufficient for a substantially longer period of operation and consequently a substantially longer protective effect is provided by means of the tank drainage device. Following a tripping of the thermostatic switch 7 and continuing low outside temperature, the power consumption of the timing element 6 remains as an electrical load on the vehicle battery. This is acceptable, however, since to that end the tank drainage device has already deployed its protective effect.

### LIST OF REFERENCE SIGNS

1 Tank

2 Drainage valve

3 Inlet

4 Outlet, drainage line

5 Supply line

6 Timing element

7 Thermostatic switch

8 Ultrasonic sensor

9 Control device

V Voltage supply

1-4. (canceled)

5. A tank drainage device for a fresh water tank on a rail vehicle, the tank drainage device comprising:
a drainage line for draining the fresh water tank;
a drainage valve associated with said drainage line;
a timing element associated with said drainage valve; and
a thermostatic switch disposed on said drainage line and thermally coupled to the fresh water;
said thermostatic switch triggering said timing element and causing said timing element to open said drainage valve for a predefined period of time upon a temperature in the fresh water tank falling below a predefined temperature.

6. The tank drainage device according to claim 5, wherein said thermostatic switch has a turn-on value, a turn-off value and a difference of less than 5 Kelvin between said turn-on value and said turn-off value.

7. The tank drainage device according to claim 5, wherein said timing element has an energy supply terminal and a control input, and said thermostatic switch outputs an electrical voltage to both said energy supply terminal and said control input of said timing element.

8. The tank drainage device according to claim 5, wherein said timing element opens said drainage valve for a maximum of 45 minutes when triggered by said thermostatic switch.
